(19) United States
(12) Patent Application Publication
(10) Pub. No.: US 2010/0068556 A1
(43) Pub. Date: Mar. 18, 2010

(54) Diffusion barrier layer and methods of forming

(75) Inventors: John Lemmon, Schoharie, NY (US); Don Lipkin, Niskayuna, NY (US); Liang Jiang, Schenectady, NY (US); Melvin Jackson, Corea, ME (US); Ji-Cheng Zhao, Latham, NY (US); Ann Ritter, Niskayuna, NY (US); Ramgopal Darolia, West Chester, OH (US); Daniel Lewis, Delmar, NY (US); Mark Gorman, West Chester, OH (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: General Electric Company

(21) Appl. No.: 11/298,811

(22) Filed: Dec. 9, 2005

(51) Int. Cl. B05D 5/00; C09D 1/00; B32B 15/00; B05D 7/00

(52) U.S. Cl. 428/632; 106/286.2; 427/405; 427/287

(57) ABSTRACT

A diffusion barrier coating includes, in an exemplary embodiment, a composition selected from the group consisting of a solid-solution alloy comprising rhenium and ruthenium wherein the ruthenium comprises about 50 atom % or less of the composition and where a total amount of rhenium and ruthenium is greater than 70 atom %; an intermetallic compound including at least one of Ru(TaAl) and Ru₂TaAl, where Ru(TaAl) has a B2 structure and Ru₂TaAl has a Heusler structure; and an oxide dispersed in a metallic matrix wherein greater than about 50 volume percent of the matrix comprises the oxide.

### BACKGROUND OF THE INVENTION

This invention generally relates to coating systems for protecting metal substrates. More specifically, the invention is directed to a diffusion barrier layer disposed between a superalloy substrate and a protective coating for the substrate.

Metal components are used in a wide variety of industrial applications, under a diverse set of operating conditions. As an example, the various superalloy components used in turbine engines are exposed to high temperatures, e.g., above about 750° C. Moreover, the alloys may be subjected to repeated temperature cycling, e.g., exposure to high temperatures, followed by cooling to room temperature, and then followed by rapid re-heating. These components thus require coatings which protect them against isothermal and cyclic oxidation, and high temperature corrosion attack.

Various types of coatings are used to protect superalloys and other types of high-performance metals. One type is based on a material like MCrAl(X), where M is nickel, cobalt, or iron, and X is Y, Ta, Re, Ru, Pt, Si, B, C, Hf, or Zr. The MCrAl(X) coatings can be applied by many techniques, such as high velocity oxy-fuel (HVOF); plasma spray, or electron beam-physical vapor deposition (EB-PVD). Another type of protective coating is an aluminide material, such as nickel-aluminide or platinum-nickel-aluminide. Many techniques can be used to apply these coatings. For example, platinum can be electroplated onto the substrate, followed by a diffusion step, which is then followed by an aluminiding step, such as pack aluminiding. These types of coatings usually have relatively high aluminum content as compared to the superalloy substrates. The coatings often function as the primary protective layer (e.g., an environmental coating). As an alternative, these coatings can serve as bond layers for subsequently-applied overlayers, e.g., thermal barrier coatings (TBC's).

When the protective coatings and substrates are exposed to a hot, oxidative, corrosive environment (as in the case of a gas turbine engine), various metallurgical processes occur. For example, a highly-adherent alumina (Al₂O₃) layer (“scale”) usually forms on top of the protective coatings. This oxide scale is usually very desirable because of the protection it provides to the underlying coating and substrate.

At elevated temperatures, there is often a great deal of interdiffusion of elemental components between the coating and the substrate. The interdiffusion can change the chemical characteristics of each of these regions, while also changing the characteristics of the oxide scale. In general, there is a tendency for the aluminum from the aluminum-rich protective layer to migrate inwardly toward the substrate. At the same time, traditional alloying elements in the substrate (e.g., a superalloy), such as cobalt, tungsten, chromium, rhenium, tantalum, molybdenum, and/or titanium, tend to migrate from the substrate into the coating. These effects occur as a result of composition gradients between the substrate and the coating.

Aluminum diffusion into the substrate reduces the concentration of aluminum in the outer regions of the protective coatings. This reduction in concentration will reduce the ability of the outer region to regenerate the highly-protective alumina layer. Moreover, the aluminum diffusion can result in the formation of a diffusion zone in an airfoil wall, which undesirably modifies the properties of a portion of the wall. Simultaneously, migration of the traditional alloying elements like molybdenum and tungsten from the substrate into the coating can also prevent the formation of an adequate protective alumina layer.

A diffusion barrier between the coating and the substrate alloy can prolong coating life by eliminating or greatly reducing the interdiffusion of elemental components, as discussed above. Diffusion barrier layers have been used for this purpose in the past, as exemplified by U.S. Pat. No. 5,556,713, issued to Leverant. The Leverant patent describes a diffusion barrier layer formed of a submicron layer of rhenium (Re). While such a layer may be useful in some situations, there are considerable disadvantages as well. For example, as the temperature increases, e.g., the firing temperature for a turbine, interdiffusion between the coating and the substrate becomes more severe. The very thin layer of rhenium may be insufficient for reducing the interdiffusion. A thicker barrier layer of rhenium could be used, but there would be a substantial mismatch in the coefficient of thermal expansion (CTE) between such a layer and a superalloy substrate. The CTE mismatch may cause the overlying coating to spall during thermal cycling of the part. Moreover, rhenium can be oxidized rapidly, which may also induce premature spallation of the coating.

### BRIEF DESCRIPTION OF THE INVENTION

In one aspect, a diffusion barrier coating is provided. The diffusion barrier coating includes a composition selected from the group consisting of a solid-solution alloy comprising rhenium and ruthenium wherein the ruthenium comprises about 50 atom % or less of the composition and where a total amount of rhenium and ruthenium is greater than 70 atom %; an intermetallic compound including at least one of Ru(TaAl) and Ru₂TaAl, where Ru(TaAl) has a B2 structure and Ru₂TaAl has a Heusler structure; and an oxide dispersed in a metallic matrix wherein greater than about 50 volume percent of the matrix comprises the oxide.

In another aspect, a turbine engine component is provided. The turbine engine component includes a metal substrate, a diffusion barrier layer overlying the metal substrate, and an oxidation-resistant coating over the diffusion barrier layer. The diffusion barrier coating includes a composition selected from the group consisting of a solid-solution alloy comprising rhenium and ruthenium wherein the ruthenium comprises about 50 atom % or less of the composition and where a total amount of rhenium and ruthenium is greater than 70 atom %; an intermetallic compound including at least one of Ru(TaAl) and Ru₂TaAl, where Ru(TaAl) has a B2 structure and Ru₂TaAl has a Heusler structure; and an oxide dispersed in a metallic matrix wherein greater than about 50 volume percent of the matrix comprises the oxide.

In another aspect, a method of protecting a surface of a superalloy substrate is provided. The method includes the steps of applying a diffusion barrier coating onto the surface of the substrate to form a diffusion barrier layer having a thickness of about 1μ to about 50μ, and applying an oxidation resistant coating over the barrier layer. The diffusion barrier coating includes a composition selected from the group consisting of a solid-solution alloy comprising rhenium and ruthenium wherein the ruthenium comprises about 50 atom % or less of the composition and where a total amount of rhenium and ruthenium is greater than 70 atom %; an intermetallic compound including at least one of Ru(TaAl) and Ru₂TaAl, where Ru(TaAl) has a B2 structure and Ru₂TaAl has a Heusler structure; and an oxide dispersed in a metallic matrix wherein greater than about 50 volume percent of the matrix comprises the oxide.

### BRIEF DESCRIPTION OF THE DRAWINGS

FIG. 1 is a sectional schematic illustration of a protective coating system applied to a metal substrate in accordance with an exemplary embodiment of the present invention.

FIG. 2 is a sectional schematic illustration of the diffusion barrier coating, shown in FIG. 1, applied as multiple layers.

FIG. 3 is a sectional schematic illustration of the diffusion barrier coating, shown in FIG. 1, applied as a discontinuous layer.

### DETAILED DESCRIPTION OF THE INVENTION

A barrier coating material for a metal component, such as a turbine blade or vane is described in detail below. The diffusion barrier coating is one of three types of material composition. In one embodiment, the barrier coating is a solid-solution alloy which contains mainly rhenium and ruthenium wherein the ruthenium comprises about 50 atom % or less of the composition and where the total amount of rhenium and ruthenium is greater than 70%. The solid-solution alloy can also include up to about 30 atom % of at least one of tungsten, nickel, cobalt, iron, chromium, tantalum, platinum, rhodium, iridium, aluminum, and incidental impurities, such as zirconium, hafnium, carbon, boron, and the like. In another embodiment, the diffusion barrier coating is an intermetallic compound that includes Ru(TaAl) or Ru₂TaAl. The intermetallic compound Ru(TaAl) has a B2 structure identical to NiAl, and can further include up to about 30 atom % of at least one of tungsten, nickel, cobalt, iron, chromium, tantalum, platinum, rhodium, iridium, aluminum, and incidental impurities, such as zirconium, hafnium, carbon, boron, and the like. The intermetallic compound Ru₂TaAl has a Heusler structure, and can further include up to about 30 atom % of at least one of tungsten, nickel, cobalt, iron, chromium, tantalum, platinum, rhodium, iridium, aluminum, and incidental impurities, such as zirconium, hafnium, carbon, boron, and the like. In another embodiment, the diffusion barrier coating is an oxide dispersed in a metallic matrix, with greater than about 50 volume percent of the matrix comprising the oxide. The metallic matrix can be MCrAl(X), nickel aluminde, or platinum modified nickel aluminide. Also, the metallic matrix can be a superalloy composition such as Ni- or Co-based alloys.

As used herein, “barrier coating” (or “barrier layer”) is meant to describe a layer of material which prevents the substantial migration of coating elements, for example, aluminum and/or platinum, from an overlying coating to an underlying substrate. In some exemplary embodiments, the barrier coating also prevents substantial migration of alloy elements of the substrate into the coating. Non-limiting examples of alloy elements from the substrate are nickel, cobalt, iron, aluminum, chromium, refractory metals, hafnium, carbon, boron, yttrium, titanium, and combinations thereof. Of that group, those elements which often have the greatest tendency to migrate into the overlying coating at elevated surface temperatures are nickel, chromium, cobalt, molybdenum, titanium, tantalum, carbon, and boron. The barrier coatings are also relatively thermodynamically and kinetically stable at the service temperatures encountered by the metal component.

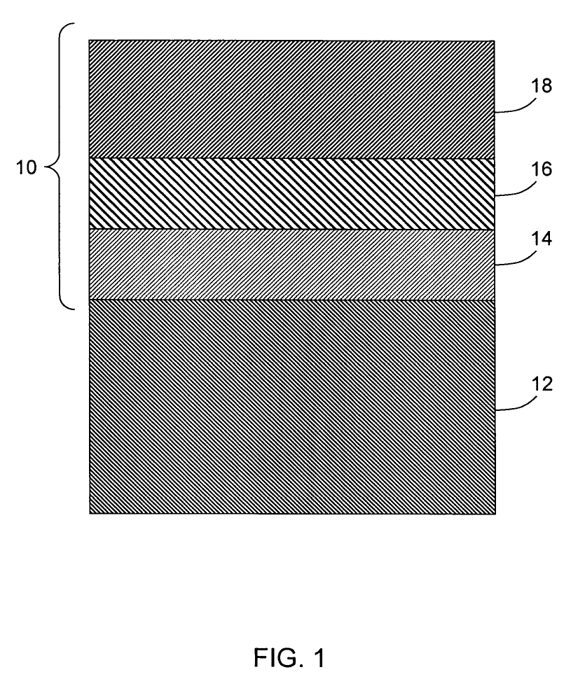

Referring to the drawings, FIG. 1 is sectional schematic illustration of a protective coating system 10 applied to a metal substrate 12, for example, a superalloy. In an exemplary embodiment, a diffusion barrier coating, which forms a diffusion barrier layer 14, is applied over metal substrate 12, and a bond coat 16 is disposed over diffusion barrier layer 14. A thermal barrier coating (TBC) 18 is disposed over bond coat 16.

In one exemplary embodiment, the diffusion barrier coating that forms diffusion barrier layer 14 includes rhenium (Re) and ruthenium (Ru) where Ru comprises about 50 atom % of the diffusion barrier coating composition. In an alternate embodiment, the diffusion barrier coating composition includes about 10 atom % to about 50 atom % Ru. In other embodiments, the diffusion barrier coating composition includes up to about 30 atom % of at least one other element, for example, tungsten, nickel, cobalt, iron, aluminum, chromium, and mixtures thereof. Re and Ru have a high melting point, a HCP (hexagonal-close-packed) crystal structure, and relatively low solubility of the elements in bond coat 16 and metal substrate 12. Diffusion barrier layer 14 containing both Re and Ru is effective in reducing the diffusion and reducing the solubility of active interdiffusion elements, such as, nickel, cobalt, iron, aluminum, chromium, refractory metals, hafnium, carbon, boron, yttrium, titanium, and platinum group metals, for example, Rh, Pt, and Pd.

In alternate exemplary embodiments, the diffusion barrier coating includes either Ru(TaAl) or Ru₂TaAl, which are intermetallic phase materials that have low solubility of, for example, nickel, cobalt, iron, aluminum, chromium, refractory metals, hafnium, carbon, boron, yttrium, and titanium. Ru(TaAl) and Ru₂TaAl are metallurgically stable between bond coat 16 and substrate 12, and have a narrow stoichiometric Al concentration. Barrier coatings containing Ru(TaAl) or Ru₂TaAl can be used to form diffusion barrier layer 14 to prevent the diffusion of nickel, cobalt, iron, aluminum, chromium, refractory metals, hafnium, carbon, boron, yttrium, and titanium from substrate 12 into coatings such as MCrAl(X), aluminide, or platinum group containing coatings.

In further exemplary embodiments, the diffusion barrier coating includes an oxide-dispersion metal matrix where greater than about 50 volume % of the matrix is the oxide. Diffusion barrier layer 14 formed from an oxide dispersed in a metal matrix acts as a physical barrier to prevent the diffusion of metallic elements from bond coat 16 and TBC 18 into substrate 12 and the diffusion of metallic elements from substrate 12 into bond coat 16 and TBC 18. In one exemplary embodiment, the oxide dispersed in the metal matrix is alumina. The matrix can be a coating alloy, for example, MCrAl(X) or aluminide, or a substrate alloy, for example, Ni- or Co-based alloys.

Methods for combining the various alloy constituents into a desired coating material are well-known in the art. As a non-limiting example, the elements can be combined by induction melting, followed by powder atomization. Melt-type techniques for this purpose are known in the art, e.g., U.S. Pat. No. 4,200,459, which is incorporated herein by reference. Another embodiment of this invention is directed to an article that can be successfully employed in a high-temperature, oxidative environment. The article includes a metal-based substrate. While the substrate may be formed from a variety of different metals or metal alloys, it is usually a heat-resistant alloy, e.g., superalloys which typically have a maximum operating temperature of about 1000° C. to about 1200° C.

The term “superalloy” is usually intended to embrace complex cobalt-, nickel-, or iron-based alloys which include one or more other elements, such as chromium, rhenium, aluminum, tungsten, molybdenum, and titanium. Superalloys are described in various references, e.g., U.S. Pat. Nos. 5,399,313 and 4,116,723, both incorporated herein by reference. The actual configuration of the substrate can vary widely. For example, the substrate can be in the form of various turbine engine parts, such as combustor liners, combustor domes, shrouds, buckets, blades, nozzles, airfoils or vanes.

Methods for applying the barrier coating composition over substrate 12 to form diffusion barrier layer 14 are well-known in the art. Suitable application methods include, but are not limited to, electron beam physical vapor deposition (EB-PVD); electroplating; ion plasma deposition (IPD); low pressure plasma spray (LPPS); chemical vapor deposition (CVD), air plasma spray (APS), high velocity oxy-fuel (HVOF), sputtering, and the like. Very often, single-stage processes can deposit the entire coating chemistry. Those skilled in the art can adapt the diffusion barrier coating composition to various types of equipment. For example, the alloy coating elements could be incorporated into a target in the case of ion plasma deposition.

The thickness of barrier layer 14 will depend on a variety of factors. Illustrative considerations include: the particular composition of substrate 12 and the layer (or layers) applied over barrier layer 14; the intended end use for the article; the expected temperature and temperature patterns to which the article itself will be subjected; and the intended service life and repair intervals for the coating system. When used for a turbine engine application (e.g., an airfoil), barrier layer 14, in one embodiment, has a thickness in the range of about 1 micrometers (μ) to about 50μ, and in another embodiment, in the range of about 5μ to about 20μ. It should be noted, though, that these ranges may be varied considerably to suit the needs of a particular end use. Moreover, for other types of applications, the thickness of the barrier layer can be as high as about 100μ.

In an alternate embodiment, barrier layer 14 is formed by depositing diffusion barrier coating composition that is off from the desired composition a predetermined amount. The off-target diffusion barrier coating composition then reacts with substrate 12 and bond coat 16 during heat treatment or the high temperature operation of the coated component which causes the resultant barrier layer 14 to have the predetermined on-target composition.

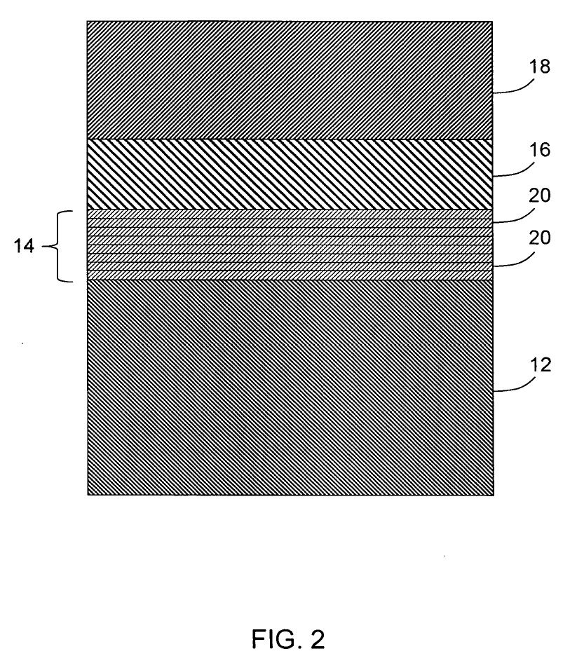

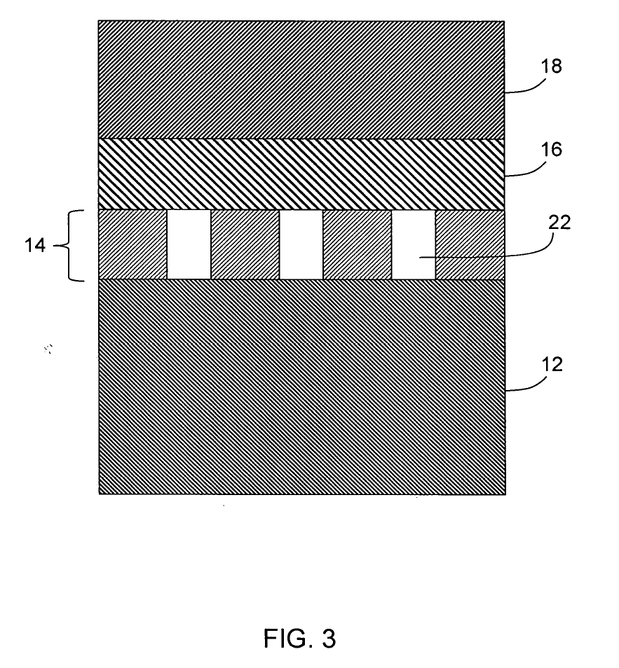

In the exemplary embodiment shown in FIG. 1, diffusion barrier layer 14 is formed as one continuous layer. In an alternate embodiment, diffusion barrier layer is formed by a plurality of layers 20 of the barrier coating composition applied to substrate 12 as shown in FIG. 2. In an other embodiment, shown in FIG. 3, diffusion barrier layer 14 is discontinuous that includes non-diffusion barrier areas 22.

Sometimes, a heat treatment is performed after the barrier layer is applied over the substrate. The purpose of the heat treatment is to improve adhesion and to enhance the chemical equilibration between the barrier layer and the substrate. The treatment is often carried out at a temperature in the range of about 950° C. to about 1200° C., for up to about 10 hours.

Various types of protective coatings may be applied over the barrier layer, depending on the service requirements of the article. In most cases, the coatings are selected to provide the necessary amount of oxidation resistance for the article. The oxidation-resistant coating often has a higher aluminum level than the substrate, such as, an aluminide or alloy coating or an overlay coating. Examples of the aluminide coatings are nickel-aluminide, noble metal-aluminide, and nickel-noble metal-aluminide. Various techniques can be used to apply these coatings. For example, a noble metal such as platinum can first be electroplated onto the barrier layer. A diffusion step can then be carried out. The diffusion step can be followed by the deposition of a layer of nickel, cobalt, or iron (or any combination thereof). This Ni/Co/Fe layer can be applied over the surface by plating, spraying, or any other convenient means. An aluminiding step, such as pack aluminiding, can then be undertaken.

Alternatively, the Ni/Co/Fe layer can be applied first, followed by the deposition of the noble metal. The diffusion step can then be carried out, followed by the aluminiding step. Those of skill in the art can select the most appropriate coating technique and coating step-sequence for a given situation. Moreover, additional, conventional heat-treatment steps can be undertaken after the various deposition steps (including that of the TBC, mentioned below).

These types of coatings are often referred to as “diffusion coatings”, and usually have relatively high aluminum content as compared to superalloy substrates. The coatings often function as the primary protective layer (e.g., an environmental coating). In the case of a turbine engine application, the aluminide coating usually has a thickness, in one embodiment, in the range of about 20μ to about 200μ, and in another embodiment, in the range of about 25μ to about 75μ.

Overlay coatings are known in the art, and generally have the composition MCrAl(X). In that formula, M is an element selected from the group consisting of Ni, Co, Fe, and combinations thereof; and X is an element selected from the group consisting of Y, Ta, Re, Ru, Pt, Si, Hf, B, C, Ti, Zr, and combinations thereof. In contrast to diffusion coatings, overlay coatings are generally deposited intact, without reaction with any separately-deposited layers. Suitable techniques were mentioned above, e.g., HVOF, plasma spray, and the like. In the case of a turbine engine application, the overlay coating usually has a thickness, in one embodiment, in the range of about 10μ to about 400μ, and in another embodiment, in the range of about 25μ to about 300μ.

Another type of oxidation-resistant coating which may be used is a “chromia-former”. Examples include nickel-chrome alloys, e.g., those containing from about 20 atom % to about 50 atom % chromium. Such coatings can be applied by conventional techniques, and often contain various other constituents as well, e.g., manganese, silicon, and/or rare earth elements.

In some embodiments, a ceramic coating, such as a TBC, can be applied over the oxidation-resistant coating. TBC's provide a higher level of heat resistance when the article is to be exposed to very high temperatures. TBC's are often used as overcoats for turbine blades and vanes. The TBC is usually (but not always) zirconia-based. As used herein, “zirconia-based” embraces ceramic materials which contain at least about 70% zirconia, by weight. In preferred embodiments, the zirconia is chemically stabilized by being blended with a material such as yttrium oxide (yttria), calcium oxide, magnesium oxide, cerium oxide, scandium oxide, or mixtures of any of those materials.

The thickness of the TBC will depend on many of the factors set forth above. In one embodiment, the TBC thickness is in the range of about 50μ to about 1500μ. In alternate embodiments for end uses such as turbine engine airfoil components, the thickness is often in the range of about 75μ to about 500μ.

While the invention has been described in terms of various specific embodiments, those skilled in the art will recognize that the invention can be practiced with modification within the spirit and scope of the claims.

What is claimed is:

1. A diffusion barrier coating comprising a composition selected from the group consisting of:
a solid-solution alloy comprising rhenium and ruthenium wherein said ruthenium comprises about 50 atom % or less of said composition, and a total amount of rhenium and ruthenium is greater than about 70 atom %;
an intermetallic compound comprising at least one of Ru(TaAl) and Ru₂TaAl, said Ru(TaAl) having a B2 structure and said Ru₂TaAl having a Heusler structure; and
an oxide dispersed in a metallic matrix, wherein greater than about 50 volume percent of said matrix comprises said oxide.

2. A diffusion barrier coating in accordance with claim 1 wherein said rhenium and ruthenium composition comprises about 10 atom % to about 50 atom % ruthenium.

3. A diffusion barrier coating in accordance with claim 1 further comprising up to about 30 atom % of at least one of tungsten, nickel, cobalt, iron, chromium, tantalum, platinum, rhodium, iridium, aluminum, zirconium, hafnium, carbon, and boron.

4. A diffusion barrier coating in accordance with claim 1 wherein after deposition onto a surface, said coating forms a diffusion barrier layer having a thickness of about 1μ to about 50μ.

5. A diffusion barrier coating in accordance with claim 1 wherein after deposition onto a surface, said coating forms a diffusion barrier layer having a thickness of about 5μ to about 20μ.

6. A diffusion barrier coating in accordance with claim 1 wherein said oxide comprises alumina, and said metallic matrix comprises MCrAl(X), nickel aluminde, platinum nickel aluminide, a Ni-based superalloy, or a Co-based superalloy, where X is at least one of Y, Ta, Re, Ru, Pt, Si, B, C, Hf, and Zr, and M is at least one of Ni, Co, and Fe.

7. A turbine engine component comprising:
a metal substrate;
a diffusion barrier layer overlying said metal substrate; and
an oxidation-resistant coating over said diffusion barrier layer;
said diffusion barrier layer comprising a composition selected from the group consisting of:
a solid-solution alloy comprising rhenium and ruthenium wherein said ruthenium comprises about 50 atom % or less of said composition, and a total amount of rhenium and ruthenium is greater than about 70 atom %;
an intermetallic compound comprising at least one of Ru(TaAl) and Ru₂TaAl, said Ru(TaAl) having a B2 structure and said Ru₂TaAl having a Heusler structure; and
an oxide dispersed in a metallic matrix, wherein greater than about 50 volume percent of said matrix comprises said oxide.

8. A turbine engine component in accordance with claim 7 wherein said rhenium and ruthenium composition comprises about 10 atom % to about 50 atom % ruthenium.

9. A turbine engine component in accordance with claim 7 further comprising up to about 30 atom % of at least one of tungsten, nickel, cobalt, iron, chromium, tantalum, platinum, rhodium, iridium, aluminum, zirconium, hafnium, carbon, and boron.

10. A turbine engine component in accordance with claim 7 wherein after deposition onto a surface, said coating forms a diffusion barrier layer having a thickness of about 1μ to about 50μ.

11. A turbine engine component in accordance with claim 7 wherein after deposition onto a surface, said coating forms a diffusion barrier layer having a thickness of about 5μ to about 20μ.

12. A turbine engine component in accordance with claim 7 wherein said oxide comprises alumina, and said metallic matrix comprises MCrAl(X), nickel aluminde, platinum nickel aluminide, a Ni-based superalloy, or a Co-based superalloy, where X is at least one of Y, Ta, Re, Ru, Pt, Si, B, C, Hf, and Zr, and M is at least one of Ni, Co, and Fe.

13. A turbine engine component in accordance with claim 7 wherein said diffusion barrier layer comprises a plurality of layers of said diffusion barrier composition.

14. A turbine engine component in accordance with claim 7 wherein said diffusion barrier layer comprises a single continuous layer of said diffusion barrier composition.

15. A turbine engine component in accordance with claim 7 wherein said diffusion barrier layer comprises a discontinuous layer of said diffusion barrier composition.

16. A method of protecting a surface of a superalloy substrate, said method comprising:
applying a diffusion barrier coating onto the surface of the substrate to form a diffusion barrier layer having a thickness of about 1μ to about 50μ; and
applying an oxidation resistant coating over the barrier layer;
the diffusion barrier layer comprising a composition selected from the group consisting of:
a solid-solution alloy comprising rhenium and ruthenium wherein said ruthenium comprises about 50 atom % or less of said composition, and a total amount of rhenium and ruthenium is greater than about 70 atom %;
an intermetallic compound comprising at least one of Ru(TaAl) and Ru₂TaAl, said Ru(TaAl) having a B2 structure and said Ru₂TaAl having a Heusler structure; and
an oxide dispersed in a metallic matrix, wherein greater than about 50 volume percent of said matrix comprises said oxide.

17. A method in accordance with claim 16 further comprising applying a thermal barrier coating over the oxidation resistant coating.

18. A method in accordance with claim 16 wherein applying a diffusion barrier coating onto the surface of the substrate comprises applying the diffusion barrier coating onto the surface of the substrate as one continuous layer.

19. A method in accordance with claim 16 wherein applying a diffusion barrier coating onto the surface of the substrate comprises applying the diffusion barrier coating onto the surface of the substrate as a plurality of layers to form the diffusion barrier layer.

20. A method in accordance with claim 16 wherein applying a diffusion barrier coating onto the surface of the substrate comprises applying the diffusion barrier coating onto the surface to form a discontinuous diffusion barrier layer.
